(19) United States
(12) Patent Application Publication
(10) Pub. No.: US 2022/0291365 A1
(43) Pub. Date: Sep. 15, 2022

(54) ULTRASONIC-WAVE TRANSMITTER/ RECEIVER

(71) Applicant: HONDA ELECTRONICS CO., LTD., Aichi (JP)

(72) Inventors: Kenji NAGAREDA, Aichi (JP); Shuichi SANO, Aichi (JP)

(21) Appl. No.: 16/978,216

(22) PCT Filed: Nov. 28, 2019
(86) PCT No.: PCT/JP2019/046515

§ 371 Date: Sep. 4, 2020

(51) Int. Cl. G01S 7/521; G01S 15/96; G10K 11/20

(52) U.S. Cl. CPC G01S 7/521; G01S 15/96; G10K 11/205

(57) ABSTRACT

The objective of this invention is to provide an ultrasonic-wave transmitter/receiver with a fastening member that enables the case of such transmitter/receiver to be fastened reliably without impairing the usability of such transmitter/receiver during normal use. The ultrasonic-wave transmitter/receiver 10 comprises an ultrasonic transducer that transmits and receives ultrasonic waves; a case 50 that houses the ultrasonic transducer; and a cable 40 that suspends the case 50. The case 50 is of a hanging-bell shape comprising a lower-half part 51 having a bottom surface 52 and an outer-peripheral surface 53; and an upper-half part 61 having a structure of which the outer diameter gradually decreases toward the upper end. At least the lower-half part 51 of the case 50 is made of an elastic body. The groove 57 extending in the circumferential direction of the lower-half part 51 is formed on the outer-peripheral surface 53 of the lower-half part 51.

### TECHNICAL FIELD

This invention relates to an ultrasonic-wave transmitter/receiver for a fish finder that detects schools of fish using ultrasonic waves.

### TECHNICAL BACKGROUND

There is a conventionally known ultrasonic-wave transmitter/receiver such that the case holding the ultrasonic transducer of such transmitter/receiver is suspended by a cable for signal transmission and is dropped into the water, so that the ultrasonic transducer transmits and receives ultrasonic waves, thus detecting any school of fish. (e.g. see Patent Documents 1 and 2). This ultrasonic-wave transmitter/receiver is used, e.g. for ice fishing such as lake-smelt fishing. The case of the ultrasonic-wave transmitter/receiver is to be inserted into the water through a hole made in the ice when ice fishing. To make it easier to pull such ultrasonic-wave transmitter/receiver up from the water, the upper-half part of it should preferably be hanging bell-shaped so as not to get caught.

### PRIOR ARTS

### Patent Document

Patent Document 1: Japanese Utility Model Publication No. S54-27648 (FIG. 2, or the like)
Patent Document 2: Japanese published unexamined patent application No. 2001-166056 (Paragraph [0006] FIG. 1, FIG. 2, or the like)

### DISCLOSURE OF THE INVENTION

### Problems to be Solved by the Invention

By the way, besides the ordinary use of suspending the case holding the ultrasonic transducer with a cable, there is also another demand in the use of the case, that it is fastened onto the holder using a fastening member such as a U-shaped bolt, a banding band or the like, so that the holder can be attached to the boat. However, even when trying to attach a fastening member to the case of the hanging bell-shaped ultrasonic-wave transmitter/receiver, as described above, such a fastening member cannot get caught on the case, and eventually the fastening member easily falls off from the case. As a result, there is then the difficult problem of fastening the case.

This invention has been achieved in light of the above-referenced problems. The purpose thereof such invention is to provide an ultrasonic-wave transmitter/receiver of which the case can be reliably fastened by using a fastening member without impairing the usability of such case during normal use.

### Means for Solving the Problems

To solve the above problems, the first aspect of this invention refers to an ultrasonic-wave transmitter/receiver for a fish-finder comprising: an ultrasonic transducer for transmitting and receiving ultrasonic waves; a case for storing such ultrasonic transducer; and a cable for suspending the case, characterized in that the case is of a hanging bell shape, with the lower-half part having a bottom surface and an outer-peripheral surface substantially perpendicular to the bottom surface, and with the upper-half part having an outer diameter gradually decreasing toward the upper end, wherein at least the lower-half part is made of an elastic body, with a groove extending in the circumferential direction of the lower-half part and which is formed on the outer-peripheral surface of the lower-half part.

As such, the first aspect of this invention allows for forming a groove on the outer-peripheral surface of the lower-half part of the case, so that a fastening member such as a U-shaped bolt or a banding band can be set in the groove. When fastening such a case to the holder using the fastening member that is set in the groove, the fastening member in the groove is then prevented from dropping out of the groove. Moreover, since the upper half of the case has a shape that does not get caught, it is possible to reliably fasten the case when the fastening member is used, without impairing the usability during normal use in which the case is suspended by the cable. Further, since the lower-half part of the case is made of an elastic body, when the fastening member that is set in the groove is tightened, such fastening member easily bites into the lower-half part of the case. In this case, since the fastening member is less likely to be displaced, it is possible more reliably to fasten the case by the fastening member. Examples of an elastic body forming the lower-half part include chloroprene rubber, neoprene rubber, polyurethane or the like.

The second aspect of this invention refers to an ultrasonic-wave transmitter/receiver according to the first aspect of this invention, characterized in that the upper-half part is an upper case opened at the lower end, and the lower-half part is a lower case opened at the upper end having a concave cross-sectional structure by integrally forming the bottom part and the side wall, wherein the lower case is made of an elastic body.

As such, according to the second aspect of this invention, the lower case, compared to the upper case, receives more impact if dropped or the like, since it configures the bottom part of the ultrasonic-wave transmitter/receiver. Yet, the lower case is made of the elastic body, so that such an impact can be reliably absorbed, thus making it possible properly to protect the ultrasonic transducer within the case. In addition, since the lower case made of an elastic body has a concave cross-sectional structure, the connecting section (corner part) between the bottom part and the side wall of the lower case, which would receive the most impact, is also made of the elastic body, thus making it possible properly to absorb more of such an impact.

The third aspect of this invention refers to an ultrasonic-wave transmitter/receiver according to the second aspect of this invention, characterized in that the upper case is made of a material harder than that of the lower case.

Therefore, according to the third aspect of the invention, since the upper case is made of a material harder than that of the lower case, the upper case is less likely to be deformed, thus the inner space of the upper case can be secured. The “harder material than that of the lower case” includes, for example, a material of a lower elastic modulus than that of the lower case.

The fourth aspect of this invention refers to an ultrasonic-wave transmitter/receiver according to the second or the third aspect of this invention, characterized in that the lower end of the upper case is fitted into the lower case through an upper-end side-opening of the lower case.

Therefore, according to the fourth aspect of this invention, in the case that the ultrasonic transducer is stored in the lower case, the size of the whole case can be reduced by making the upper case smaller. In other words, it is unnecessary to downsize the ultrasonic transducer if the case is downsized. Also, since the lower case is made of an elastic material, the lower end of the upper case can be fitted into the lower case by making the lower case elastically deformed. As such, workability in fitting the upper case into the lower case is improved. Further, since the lower end of the upper case is “fitted” into the lower case, the upper case and the lower case stay easily in close contact. Thus, a clearance is less likely to be formed between them.

The fifth aspect of the invention refers to an ultrasonic-wave transmitter/receiver according to any one of the second to fourth aspects of this invention, characterized in that the groove is formed on the outer peripheral surface of the side wall of the lower case.

Therefore, according to the fifth aspect of this invention, since the groove is formed on the lower case made of an elastic body, the lower case is less likely to be damaged when a fastening member is set in the groove. In addition, since the site where the groove is formed is made of an elastic body, a frictional force between the lower case and the fastening member is increased, so that rattling when the fastening member is tightened can be reduced. Also, when the ultrasonic-wave transmitter/receiver oscillates, the fastening member is less likely to be loosened.

The sixth aspect of this invention refers to an ultrasonic-wave transmitter/receiver according to the fifth aspect of this invention, characterized in that the groove is provided on the upper region of the side wall.

Therefore, according to the sixth aspect of this invention, a groove is provided on the upper region of the side wall of the lower case. As such, even if such a groove is formed, the thickness of the lower region of the side wall, which is easily affected by impact if dropped or the like, is secured. Therefore, such an impact can be surely absorbed by the lower case made of an elastic body.

The seventh aspect of this invention refers to an ultrasonic-wave transmitter/receiver according to any one of the first to sixth aspects of this invention, characterized in that a concave and convex part is formed on the inner surface of the groove.

Therefore, according to the seventh aspect of this invention, by providing a concave and convex part on the inner surface of the groove, a plurality of convex portions making such a concave and convex part perform an anti-slip function, so that the frictional force between the lower case and the fastening member that is set in the groove increases, thus making it possible to prevent the fastening member from falling out of the groove.

### Effects of the Invention

As described above in detail, according to the first to seventh aspects of this invention, the case, when a fastening member is used, can be reliably fastened without impairing its usability during normal use.

### BRIEF DESCRIPTION OF THE DRAWINGS

FIG. 1 is a plan view of the fastening mode of the ultrasonic-wave transmitter/receiver according to an embodiment of this invention.

FIG. 2 is a perspective view of the ultrasonic-wave transmitter/receiver.

FIG. 3 is a side view of the ultrasonic-wave transmitter/receiver.

FIG. 4 is a cross-sectional view of between the A-A line of FIG. 3.

FIG. 5 is an exploded-perspective view of the ultrasonic-wave transmitter/receiver.

FIG. 6 is a perspective view of the lower case.

FIG. 7 is a block diagram of the electrical configuration of the ultrasonic-wave transmitter/receiver.

FIG. 8 is a plan view of another fastening mode of the ultrasonic-wave transmitter/receiver.

FIG. 9 is a cross-sectional view of the ultrasonic-wave transmitter/receiver according to another embodiment of this invention.

FIG. 10(a) and FIG. 10(b) are cross-sectional views of the main part of the structure of a groove according to another embodiment of this invention.

FIG. 11 is a cross-sectional view of the main part of the structure of a groove according to another embodiment of this invention.

### DETAILED DESCRIPTION OF THE INVENTION

Hereinafter, the embodiments of this invention are described in detail with reference to the drawings.

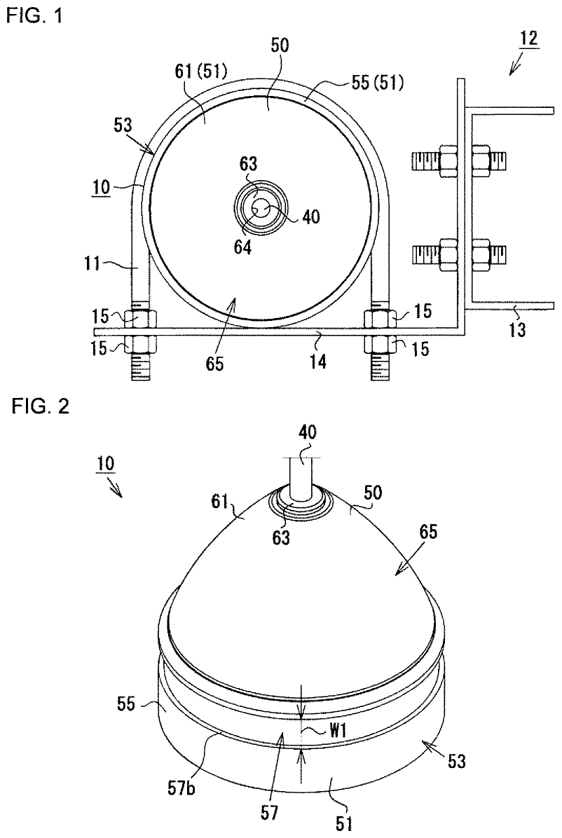

As shown in FIGS. 1, to 4, the ultrasonic-wave transmitter/receiver 10 as the embodiment of this invention is a device for a fish finder that detects schools of fish present in the water by emitting ultrasonic waves therein. The ultrasonic-wave transmitter/receiver 10 comprises an ultrasonic transducer 21 that transmits and receives ultrasonic waves; a case 50 that accommodates the ultrasonic transducer 21; and a cable 40 that suspends the case 50. As shown in FIG. 4, the ultrasonic transducer 21 includes a base material 22 and a piezoelectric element 23. The base material 22 is a disk-shaped plate-like resin object formed using glass epoxy (FR-4) that also functions as an acoustic-matching layer.

In addition, the piezoelectric element 23 is a disk-shaped ceramic plate-like object formed by using e.g. lead-zirconate titanate (PZT), which is a piezoelectric ceramic. The piezoelectric element 23 has a front surface 31 bonded to the base material 22 and a rear surface 32 opposite the front surface 31. Further, a front surface-side electrode (not shown in the drawings) is formed on the front surface 31 of the piezoelectric element 23, and a rear surface-side electrode (not shown in the drawings) is formed on the rear surface 32 of the piezoelectric element 23. Also, of this embodiment, the entire front surface 31 of the piezoelectric element 23 is joined to the base material 22 via the front surface-side electrode and to the adhesive layer (not shown in the drawings).

Also, as shown in FIG. 4, the first wiring 41 is connected to the front-side electrode, and the second wiring 42 is connected to the rear-side electrode. The first wiring 41 is connected to a side terminal (not shown in the drawings) that extends outward from the front-side electrode by soldering or the like. The second wiring 42 is connected to the outer-peripheral area of the rear-side electrode by soldering or the like. Then, the first wiring 41 and the second wiring 42 form a cable 40, and the cable 40 is guided out of the case 50 through a wiring-insertion hole 64 provided on the upper part of the case 50.

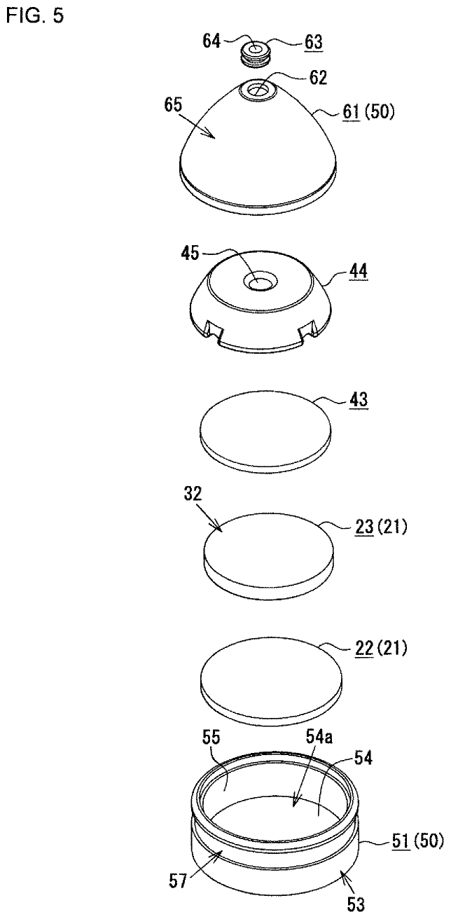

As shown in FIGS. 4 and 5, a sheet-shaped acoustic insulator 43 (backing material) is attached to the rear-side surface 32 of the piezoelectric element 23. The acoustic insulator 43 is for suppressing reverberation. As for the acoustic insulator 43, it is possible to use a resin material or rubber containing particles or fibers made of metal or ceramics or to use a resin material having pores dispersed therein (e.g. a sponge or the like).

Further, a weight 44 is arranged above the ultrasonic transducer 21, with the acoustic insulator 43 interposed there between. The weight 44 is made of zinc, lead or the like and is of a substantially circular truncated-cone shape having a cable-insertion hole 45 for inserting the cable 40 in the center. The weight 44 has the function of immersing the case 50 under water and of adjusting the balance, so that the case 50 can be vertically maintained while being suspended by the cable 40.

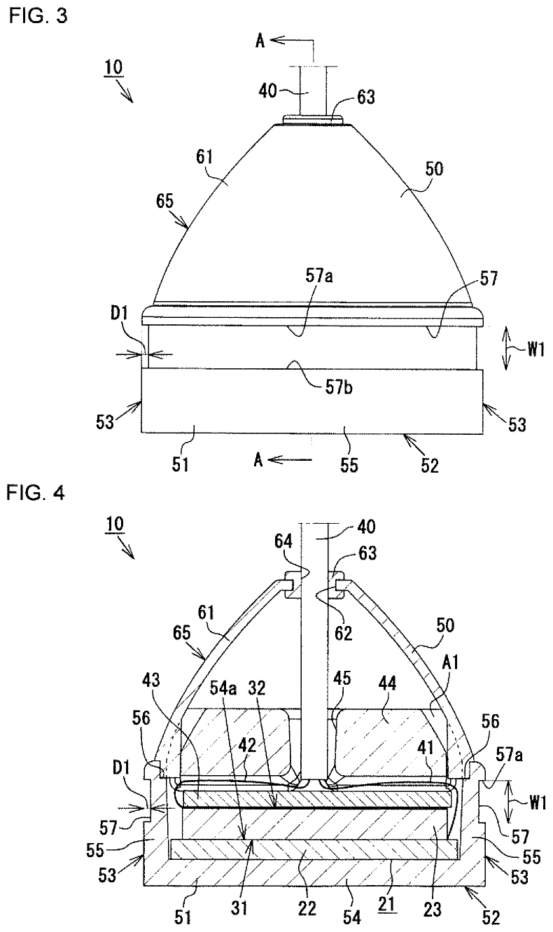

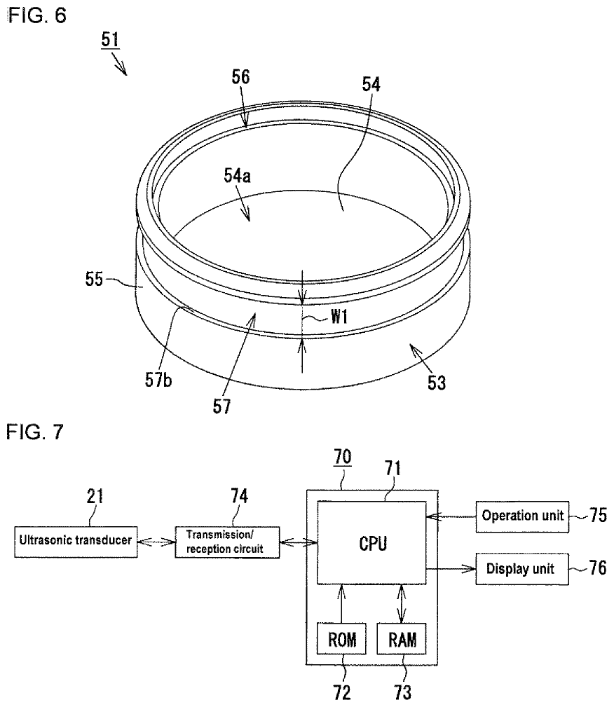

As shown in FIGS. 1 to 6, the case 50 is of a hanging-bell shape and includes the lower case 51 that forms the lower-half part of the case 50 and an upper case 61 that forms the upper-half part of the case 50. The lower case 51, made of an elastic body such as chloroprene rubber that also functions as an acoustic-matching layer, and has a bottom surface 52 and an outer-peripheral surface 53 perpendicular to the bottom surface 52. The lower case 51 is a cylindrical case with a bottom that opens at the upper end and has a concave cross-sectional structure such that the bottom portion 54 and the side wall 55 are integrally formed. The ultrasonic transducer 21 is arranged on the inner surface 54a of the bottom part 54. The lower end of the upper case 61 is fitted into the lower case 51. Also, the outer diameter of the lower end of the upper case 61 is substantially the same as the inner diameter of the upper-end side-opening of the lower case 51. A step surface 56 is formed on the upper-end side-opening part of the lower case 51 so as to contact the open end (lower end) of the upper case 61 fitted into the lower case 51 from the upper-end side opening of the lower case 51.

As shown in FIGS. 1 to 5, the upper case 61 is open at the lower end and has a structure of which the outer diameter gradually decreases toward the upper end. The upper case 61 is formed using a resin material such as ABS resin (acrylonitrile butadiene styrene resin) or PC resin (polycarbonate resin) that hardly deforms since it has very little elasticity. That is, the upper case 61 is made of a material harder than that (e.g. chloroprene rubber or the like) of the lower case 51. Further, a through-hole 62 is provided in the upper end of the upper case 61, and a bushing 63 made of chloroprene rubber, neoprene rubber or the like is fitted into the through-hole 62. The bushing 63 is of an annular shape having a wiring-insertion hole 64, as described above, in the center, and has the function of fastening the cable 40 to be inserted through the wiring-insertion hole 64.

The case 50, as shown in FIG. 4, is filled with a filler A1 made of a resin material (epoxy resin, urethane resin, silicone resin or the like) or made of an adhesive (epoxy adhesive or the like). A part of the filler A1 is filled in the cable-insertion hole 45 through which the cable 40 is inserted.

As shown in FIGS. 2 to 6, a groove 57 to be engaged with a U-shaped bolt 11 or the like, as shown in FIG. 1, is formed on the outer-peripheral surface 53 of the side wall 55 of the lower case 51. The groove 57 has a rectangular cross-sectional structure, extending along the circumferential direction of the cylindrical-shaped lower case 51, and is continuously formed over the complete periphery of the lower case 51. The groove 57 is provided on the upper region of the side wall 55. Specifically, the upper-end surface 57a of the groove 57 is located slightly below the step surface 56 (see FIG. 4), and the lower-end surface 57b of the groove 57 is located slightly higher than half the height of the side wall 55. Therefore, the width W1 of the groove 57 is ⅕ or more and ½ or less of the height of the side wall 55. The depth D1 of the groove 57 is ⅕ or more and ½ or less of the thickness of the side wall 55. Furthermore, the width W1 of the groove 57 is larger than the depth D1 of the groove 57.

Also, the ultrasonic-wave transmitter/receiver 10, as the embodiment of this invention, is used in the state of being suspended from the cable 40 during normal use (see FIGS. 2 to 4). However, the ultrasonic-wave transmitter/receiver 10 can also be used in the state of being attached to the holder 12 using the U-shaped bolt 11, which is a fastening member allowing the holder 12 to be fastened to the stern of a boat (not shown in the drawings). (See FIG. 1). Specifically, the holder 12 comprises a holder-main body 13 that vertically extends when attached to a boat and comprises a mounting plate 14 that laterally extends from the lower end of the holder-main body 13. Then, both ends of the U-shaped bolt 11, holding the ultrasonic-wave transmitter/receiver 10, are inserted into a pair of bolt-mounting holes (not shown in the drawings) provided on the mounting plate 14, and two of each of the nuts 15 are fastened to both ends of the U-shaped bolt 11, thus making it possible to fasten the ultrasonic-wave transmitters/receivers 10 to a boat via the holders 12. In addition, of this embodiment, the outer diameter (thickness) of the U-shaped bolt 11 is smaller than the width W1 of the groove 57 and greater than the depth D1 of the groove 57. Also, the inner diameter of the curved portion of the U-shaped bolt 11 is slightly less than the outer diameter of the forming-region of the groove 57 of the lower case 51.

Next, the electrical configuration of the ultrasonic-wave transmitter/receiver 10 is described.

As shown in FIG. 7, the liquid-crystal monitor (not shown in the drawings) of the ultrasonic-wave transmitter/receiver 10 comprises a controller 70 that integrally controls the whole device. The controller 70 is configured with a well-known computer including a CPU 71, a ROM 72, a RAM 73 and the like.

The CPU 71 is electrically connected to the ultrasonic transducer 21 via a transmission/reception circuit 74. The transmission/reception circuit 74 outputs an oscillation signal to the ultrasonic transducer 21 to drive the ultrasonic transducer 21. As a result, the ultrasonic transducer 21 emits (transmits) ultrasonic waves into the water. In addition, an electrical signal indicating an ultrasonic wave (reflected wave) received by the ultrasonic transducer 21 is input to the transmission/reception circuit 74. Furthermore, the CPU 71 is electrically connected to the operation unit 75 and to the display unit 76 of the liquid-crystal monitor.

Then, the CPU 71, as shown in FIG. 7, controls the transmission/reception circuit 74 so that the ultrasonic waves are emitted from the ultrasonic transducer 21. The CPU 71 also receives, via the transmission/reception circuit 74, a reception signal generated at the time when the ultrasonic transducer 21 receives the reflected waves. Then, the CPU 71 generates the detected-image data based on the reception signal and stores such detected image data in the RAM 73. The CPU 71 takes control of the display unit 76 to show the detected image based on the detected-image data stored in the RAM 73.

Hereinafter, the method for using the ultrasonic transducer 10 is described.

For the normal way of ice fishing, the case 50, which houses the ultrasonic transducer 21, is suspended by the cable 40 and immersed into the water. Then, fish finding is done by transmitting and receiving ultrasonic waves by the ultrasonic transducer 21. Specifically, firstly, turn on the power (not shown in the drawings) of the ultrasonic-wave transmitter/receiver 10 and of the liquid-crystal monitor. The liquid-crystal monitor, for example, is to be used while being held by an operator. Next, the CPU 71 of the controller 70 controls the ultrasonic transducer 21 to output an oscillation signal from the transmission/reception circuit 74 via the cable 40 so as to drive the ultrasonic transducer 21. At this time, the piezoelectric element 23 repeats contraction and extension in the thickness direction. As a result, the piezoelectric element 23 oscillates, and ultrasonic waves are emitted (transmitted) from the ultrasonic transducer 21 into the water. Then, when the ultrasonic waves reach a school of fish, the ultrasonic waves are reflected by the school of fish to become reflected waves and are then propagated toward the ultrasonic-wave transmitter/receiver 10 and then input (received) by the ultrasonic transducer 21. After that, the ultrasonic wave (reflected wave) received by the ultrasonic transducer 21 is converted into a reception signal and input to the CPU 71 via the cable 40 and via the transmission/reception circuit 74. At this time, the school of fish is detected. After that, when the operator turns off the power, the controller 70 stops the transmission/reception circuit 74, thus completing the emission of the ultrasonic waves and the reception of the reflected waves.

By the way, there is also a demand for fastening the ultrasonic-wave transmitter/receiver 10 onto the holder 12 and for attaching the holder 12 to the boat while in use (see FIG. 1). The liquid-crystal monitor is used while mounted on the boat. Specifically, first, the curved portion of the U-shaped bolt 11, which is the fastening member, is arranged in the groove 57 formed on the case 50 of the ultrasonic-wave transmitter/receiver 10. Then, in this state, the nuts 15 are respectively engaged to both ends of the U-shaped bolt 11, and then both ends of the U-shaped bolt 11 are inserted into a pair of bolt-insertion holes (not shown in the drawings) provided on the mounting plate 14 of the holder 12. Further, the ultrasonic-wave transmitter/receiver 10 is fastened onto the holder 12, with the nuts 15 being engaged to both ends of the U-shaped bolt 11 where the bolt-insertion holes are bored. After that, the holder 12 is to be attached to the boat. Then, the ultrasonic-wave transmitter/receiver 10 is attached to the boat via the holder 12.

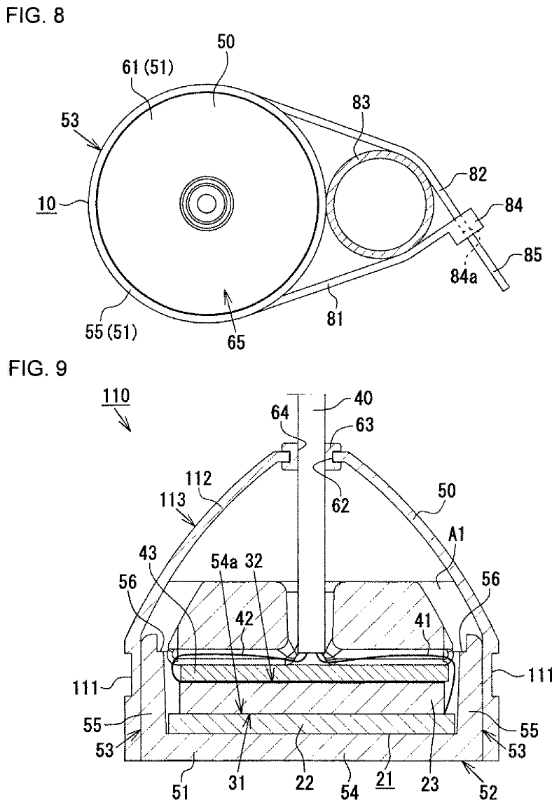

The ultrasonic-wave transmitter/receiver 10 can also be attached to a boat by using a fastening member other than the U-shaped bolt 11. In this case, again, the liquid-crystal monitor is used while being mounted on the boat. For example, as shown in FIG. 8, the ultrasonic-wave transmitter/receiver 10 is attached using the banding band 81 that is a fastening member. Specifically, first, a belt part 82 of the banding band 81 is set in the groove 57 formed on the case 50. The embodiment of this invention employs the banding band 81 of which the width of the belt part 82 is less than the width W1 of the groove 57, and the thickness of the belt part 82 is less than the depth D1 of the groove 57. Then, in this state, both ends of the belt part 82 are wound around the pipe-shaped holder 83. Further, the other end 85 of the belt part 82 is inserted into the fastening hole 84a of the fastening portion 84 provided at one end of the belt part 82, and the end 85 of the inserted belt part 82 is pulled out, thus fastening the ultrasonic-wave transmitter/receiver 10 to the holder 83. After that, the holder 83 is attached to the boat, so that the ultrasonic-wave transmitter/receiver 10 is attached to the boat via the holder 83. Also, the banding band 81 may be disposable or reusable.

Therefore, the embodiment of this invention realizes the following effects.

(1) According to the ultrasonic-wave transmitter/receiver 10 of the above embodiment, the groove 57 is formed on the outer-peripheral surface 53 of the lower case 51 that constitutes the case 50. Therefore, when a fastening member such as the U-shaped bolt 11 or the banding band 81 or the like is set in the groove 57, and the case 50 is fastened to the holder 12 by using the fastening member set in the groove 57, then the fastening member is prevented from dropping out of the groove 57. Moreover, the upper case 61, which is the upper-half part of the case 50, is shaped so as not get caught, and the groove 57 formed on the case 50 has a shape that does not protrude from the case 50. Furthermore, the groove 57 is provided on the lower case 51, which is the lower-half part of the case 50 and is provided on the side wall 55 that constitutes the vertical portion of the lower case 51. Therefore, during ice fishing and the case 50 is being suspended by the cable 40, the case 50 can be pulled up out of the water without getting caught in the hole formed in the ice. Further, since the lower case 51 is made of an elastic body, when tightening the fastening member set in the groove 57, the lower case 51 is deformed, thus easily increasing the contact area with the fastening member. In this case, the fastening member is less likely to be displaced, thus making it possible reliably to fasten the case 50 by the fastening member. Further, since the lower case 51 made of an elastic body constitutes a portion that easily receives a shock, when the ultrasonic-wave transmitter/receiver 10 is suspended or if it is dropped, such an impact can be reliably absorbed, thus making it possible surely to protect the ultrasonic transducer 21 or the like in the case 50.

(2) According to the embodiment of this invention, the groove 57 formed on the lower case 51 is located near the step surface 56 abutting the lower end of the upper case 61. Therefore, when the upper case 61 and the lower case 51 are joined, the upper case 61, which is harder than the lower case 51 and thus less likely to be deformed, is positioned substantially on the rear side of the groove 57 of the lower case 51. As a result, even if a fastening member such as the U-shaped bolt 11 or a banding band 81 or the like is set in the groove 57 for tightening, the site where the groove 57 is formed in the lower case 51 is supported by the upper case 61 and is less likely to be deformed, thus making it possible reliably to prevent the fastening member from dropping out of the groove 57.

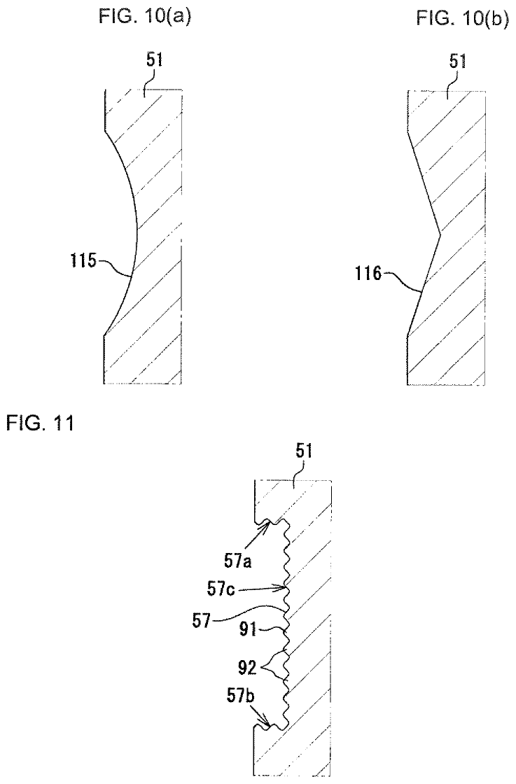

Also, each embodiment of this invention can be modified, as follows.
According to the above embodiment, the groove 57 is arranged in the upper region of the side wall 55 of the lower case 51. However, it is possible to arrange the groove 57 in the lower region of the side wall 55 or in the center of the side wall 55. Furthermore, according to the ultrasonic-wave transmitter/receiver 110, as shown in FIG. 9, the groove 111 can be formed on the outer-peripheral surface 113 of the upper case 112, not on the outer-peripheral surface 53 of the lower case 51.
According to the above embodiment, the groove 57 is of a cross-sectional rectangular shape. However, it is possible to make it another shape. For example, as shown in FIG. 10(a), the groove 115 can be of a cross-sectional arc-like shape, or, as shown in FIG. 10(b), the groove 116 can be of a cross-sectional V-shape.
According to the above embodiment, the groove 57 is continuously formed over the whole circumference of the lower case 51. However, it is possible to make it a non-continuous groove that is divided at multiple sites. It is also possible to form the groove at only part way in the circumferential direction of the lower case 51.
According to the above embodiment, the lower end of the upper case 61 is fitted into the lower case 51 from the upper-end-side opening of the lower case 51. However, in opposite fashion to that, the upper end of the lower case 51 can be fitted into the upper case 61 through the lower-end-side opening of the upper case 61.
According to the above embodiment, the upper case 61 is made of a material harder than that of the lower case 51. However, the upper case 61 can be formed of a material of the same hardness as that of the lower case 51. In other words, the upper case 61 and the lower case 51 can be both elastic bodies. Furthermore, the lower case 51 can be made of a material harder than that of the upper case 61.
According to the above embodiment, the case 50 is configured by joining the upper case 61 and the lower case 51. However, the case 50 can also be integrally formed.
According to the above embodiment, the upper case 61 and the lower case 51 are joined by fitting the lower end of the upper case 61 into the lower case 51 through the upper-end-side opening of the lower case 51. However, both cases can be joined by other ways, e.g. the upper case 61 and the lower case 51 can be joined by filling the case 50 with the filler A1 to be cured. In addition, it is possible to join the upper case 61 and the lower case 51 by inserting a screw into the screw insertion hole provided on the upper case 61 (or on the lower case 51) and then by screwing the tip of the inserted screw into the lower case 51 (or into the upper case 61). It is also possible to join the upper case 61 and the lower case 51 by using an adhesive.
According to the above embodiment, the inner surface of the groove 57 is a smooth surface. However, e.g. concave and convex part 91, as shown in FIG. 11, can be formed on the inner surface of the groove 57. Such concave and convex part 91 can also be formed by arranging a plurality of grooves of a narrow width or can be formed by emboss processing or by surface roughening, or the like. As such, a plurality of convex portions 92 making the concave and convex part 91 perform an anti-slip function, so that the frictional force between the lower case 51 and the fastening member set in the groove 57 increases, thus making it possible to prevent the fastening member from dropping out of the groove 57. Also, as shown in FIG. 11, the concave and convex part 91 is formed all over the bottom surface 57c, the upper-end surface 57a, and the lower-end surface 57b of the groove portion 57. However, the concave and convex part 91 just has to be formed on at least the bottom surface 57e of these surfaces 57a to 57c.
According to the above embodiment, the ultrasonic transducer 21 comprises the disk-shaped piezoelectric element 23. However, the ultrasonic transducer 21 may also include a piezoelectric element of a circular-ring shape or rectangular shape. Further, the ultrasonic transducer 21 may comprise a piezoelectric element having a 1-3 composite structure in which a plurality of cuts extending vertically and horizontally are formed or may comprise a piezoelectric element having a 2-2 composite structure in which a plurality of cuts extending in one direction are formed. Furthermore, it is possible to use a piezoelectric element having a 0-3 composite structure in which piezoelectric-ceramic particles are mixed with a rubber material, or to use a piezoelectric element (porous element) made of porous-piezoelectric ceramics or the like. Also, a piezoelectric element having a 1-3 composite structure, and a piezoelectric element having a 2-2 composite structure and a porous element are brittle and easily broken. However, according to the above embodiment, the lower case 51 is made of an elastic body, thus making it possible reliably to protect such piezoelectric elements.
According to the above embodiment, the weight 44 is provided on the upper side of the ultrasonic transducer 21 within the case 50, and such a weight 44 has a substantially circular truncated-cone shape having a cable insertion hole 45 for inserting the cable 40 in the center. However, the weight 44 may have any optional shape, or it may not be provided at all.

Besides the technical ideas described about this invention, other technical ideas to be understood about the described embodiments, above, are hereinafter described.

(1) A method for fastening the ultrasonic-wave transmitter/receiver, according to any one of the first to seventh aspects of this invention, characterized by comprising the step of arranging a curved portion of the U-shaped bolt in the groove formed in the case; the step of inserting both ends of the U-shaped bolt into pair of bolt-insertion holes provided on a mounting plate of the holder; and the step of fastening the case to the holder by engaging nuts to both ends of the U-shaped bolt that is inserted into the pair of bolt-insertion holes.

(2) A method for fastening the ultrasonic-wave transmitter/receiver, according to any one of the first to seventh aspects of this invention, characterized by comprising the step of arranging the belt part of a banding band in the groove formed on the case; the step 2 of winding both ends of the belt part around the pipe-shaped holder; the step 3 of inserting the other end of the belt part into the fastening hole of the fastening member provided on one end of the belt part; and the step 4 of fastening the case to the holder by pulling an end of the inserted belt part.

### DESCRIPTION OF THE REFERENCE NUMERALS

10, 110: Ultrasonic-wave transmitter/receiver
21: Ultrasonic transducer
40: Cable
50: Case
51: Lower case as the lower-half part
52: Bottom surface of the lower-half part
53: Outer periphery of the lower-half part (side wall)
54: Bottom part of the lower case (lower-half part)
55: Side wall of the lower case (lower-half part)
57, 111, 115, 116: Groove
61, 112: Upper case as the upper-half part
91: Concave and convex part

1. An ultrasonic-wave transmitter/receiver for a fish-finder comprising: an ultrasonic transducer for transmitting and receiving ultrasonic waves; a case for storing such ultrasonic transducer; and a cable for suspending the case, characterized in that the case is of a hanging bell shape, with the lower-half part having a bottom surface and an outer-peripheral surface substantially perpendicular to the bottom surface, and with the upper-half part having an outer diameter gradually decreasing toward the upper end, wherein at least the lower-half part is made of an elastic body, with a groove extending in the circumferential direction of the lower-half part and which is formed on the outer-peripheral surface of the lower-half part.

2. An ultrasonic-wave transmitter/receiver according to claim 1, characterized in that the upper-half part is an upper case opened at the lower end, and the lower-half part is a lower case opened at the upper end having a concave cross-sectional structure by integrally forming the bottom part and the side wall, wherein the lower case is made of an elastic body.

3. An ultrasonic-wave transmitter/receiver according to claim 2, characterized in that the upper case is made of a material harder than that of the lower case.

4. An ultrasonic-wave transmitter/receiver according to claim 2, characterized in that the lower end of the upper case is fitted into the lower case through an upper-end side-opening of the lower case.

5. An ultrasonic wave transmitter/receiver according to claim 2, characterized in that the groove is formed on the outer peripheral surface of the side wall of the lower case.

6. An ultrasonic wave transmitter/receiver according to claim 5, characterized in that the groove is provided on the upper region of the side wall.

7. An ultrasonic wave transmitter/receiver according to claim 1, characterized in that a concave and convex part is formed on the inner surface of the groove.
